(19) United States
(12) Patent Application Publication
(10) Pub. No.: US 2025/0073828 A1
(43) Pub. Date: Mar. 6, 2025

(54) Welding Device

(71) Applicants: TE Connectivity Solutions GmbH, Schaffhausen (CH); Tyco Electronics (Shanghai) Co., Ltd., Shanghai (CN); Kunshan League Automechanism Co., Ltd, Kunshan City (CN)

(72) Inventors: Zongjie (Jason) Tao, Shanghai (CN); Dandan (Emily) Zhang, Shanghai (CN); Robert Francisco-Yi Lu, Bellevue, WA (US); Haidong Wu, Kunshan City (CN)

(73) Assignees: TE Connectivity Solutions GmbH, Schaffhausen (CH); Tyco Electronics (Shanghai) Co., Ltd., Shanghai (CN); Kunshan League Automechanism Co., Ltd, Kunshan City (CN)

(21) Appl. No.: 18/824,500

(22) Filed: Sep. 4, 2024

(30) Foreign Application Priority Data
Sep. 5, 2023 (CN) 202311141606.2

(51) Int. Cl. B23K 37/02; B23K 9/095; B23K 9/32; B25J 9/02; B25J 15/00

(52) U.S. Cl. CPC B23K 37/0229; B23K 9/0956; B23K 9/328; B25J 9/026; B25J 15/0019

(57) ABSTRACT

A welding device includes a frame body, a first movable module, a second movable module, a third movable module, and a welding module. The first movable module is installed on the frame body and movable in a first horizontal direction. The second movable module is installed on the first movable module and movable in a second horizontal direction perpendicular to the first horizontal direction. The third movable module is installed on the second movable module and movable in a vertical direction perpendicular to the first and second horizontal directions. The welding module is installed on the third movable module and movable together with the first, second, and third movable modules. The welding module is suspended outside the frame body, and the first movable module is provided in an inner chamber of the frame body to reduce the distance between the welding module and the frame body.

### CROSS-REFERENCE TO RELATED APPLICATION

This application claims the benefit of Chinese Patent Application No. CN202311141606.2 filed on Sep. 5, 2023 in the State Intellectual Property Office of China, the whole disclosure of which is incorporated herein by reference.

### FIELD OF THE DISCLOSURE

The present disclosure relates to a welding device.

### BACKGROUND OF THE INVENTION

In the prior art, the welding device typically includes a multi degree of freedom robotic arm and a welding head installed at the end of the robotic arm. However, the rigidity and stability of the robotic arm are poor, making it difficult to accurately control the position of the welding head and reducing welding accuracy. In addition, the structure of the robotic arm is complex, difficult to control, and costly.

### SUMMARY OF THE INVENTION

According to an embodiment of the present disclosure, a welding device includes a frame body, a first movable module, a second movable module, a third movable module, and a welding module. The first movable module is installed on the frame body and movable in a first horizontal direction. The second movable module is installed on the first movable module and movable in a second horizontal direction perpendicular to the first horizontal direction. The third movable module is installed on the second movable module and movable in a vertical direction perpendicular to the first and second horizontal directions. The welding module is installed on the third movable module and movable together with the first, second, and third movable modules. The welding module is suspended outside the frame body, and the first movable module is provided in an inner chamber of the frame body to reduce the distance between the welding module and the frame body.

### BRIEF DESCRIPTION OF DRAWINGS

The disclosure will now be described by way of example with reference to the accompanying Figures, of which:

FIG. 1 shows an illustrative perspective view of a welding device according to an exemplary embodiment of the present invention;

FIG. 2 shows an illustrative perspective view of a welding device according to an exemplary embodiment of the present invention; and

FIG. 3 shows a side view of a welding device according to an exemplary embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a welding device comprises: a frame body; a first movable module which is installed on the frame body and can be moved in a first horizontal direction; a second movable module which is installed on the first movable module and can be moved in a second horizontal direction perpendicular to the first horizontal direction; a third movable module which is installed on the second movable module and can be moved in a vertical direction perpendicular to the first and second horizontal directions; and a welding module which is installed on the third movable module and capable of being moved together with the first, second, and third movable modules. The welding module is suspended outside the frame body. The first movable module is provided in an inner chamber of the frame body to reduce the distance between the welding module and the frame body.

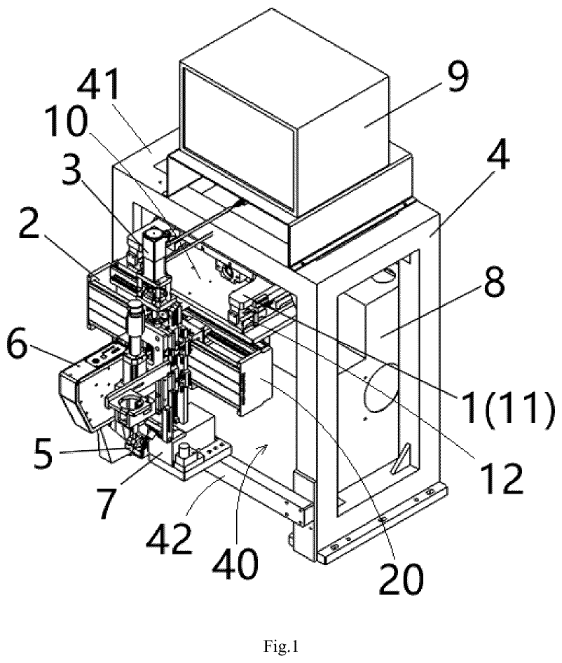

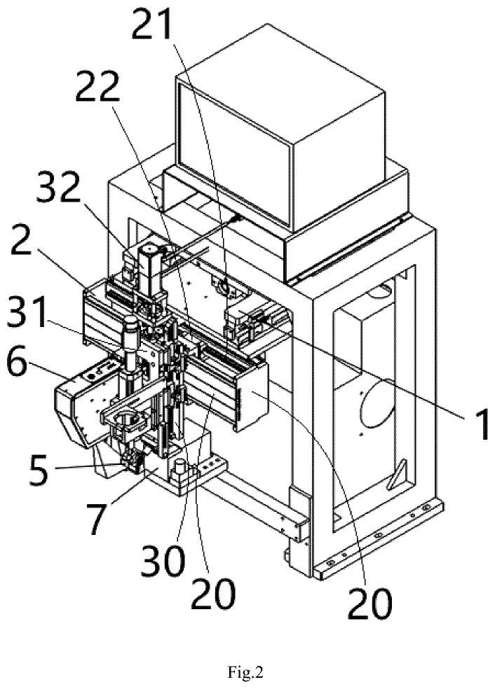

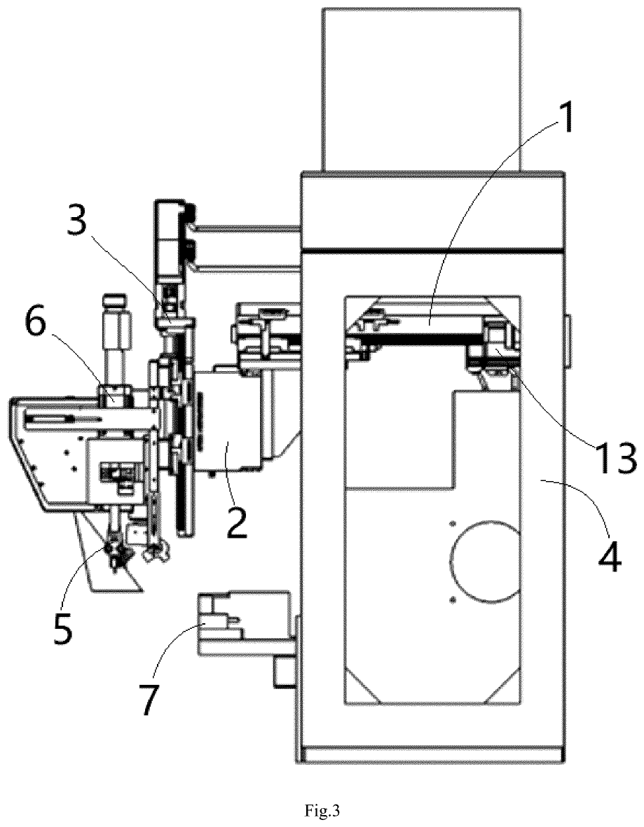

FIG. 1 shows an illustrative perspective view of a welding device according to an exemplary embodiment of the present invention. FIG. 2 shows an illustrative perspective view of a welding device according to an exemplary embodiment of the present invention. FIG. 3 shows a side view of a welding device according to an exemplary embodiment of the present invention.

As shown in FIGS. 1-3, in an exemplary embodiment of the present invention, a welding device is disclosed. The welding device includes: a frame body 4, a first movable module 1, a second movable module 2, a third movable module 3, and a welding module 5. The first movable module 1 is installed on the frame body 4 and can move in a first horizontal direction. The second movable module 2 is installed on the first movable module 1 and can move in a second horizontal direction perpendicular to the first horizontal direction. The third movable module 3 is installed on the second movable module 2 and can move in a vertical direction perpendicular to the first and second horizontal directions. The welding module 5 is installed on the third movable module 3 and can move together with the first movable module 1, the second movable module 2, and the third movable module 3. Therefore, the entire welding device has three degrees of freedom.

The welding module 5 is suspended outside the frame body 4, and the first movable module 1 is set in the inner chamber 40 of the frame body 4 to reduce the distance between the welding module 5 and the frame body 4. In the present invention, due to the small spacing between the welding module 5 and the fixed frame body 4, the welding device has good rigidity and stability, and the welding module 5 is not prone to uncontrollable vibration, thereby improving the welding accuracy.

The first movable module 1 includes: a pair of first slide rails 11 and a pair of first sliders 12. The pair of first slide rails 11 extend along the first horizontal direction and are spaced at a predetermined distance in the second horizontal direction. The pair of first sliders 12 are respectively installed onto the pair of first sliders 11. The frame body 4 has a top frame 41, and the first slide rail 11 is fixed to the inner side of the top frame 41.

The first movable module 1 further comprises a horizontal mounting plate 10 and a first driving device 13. The pair of first sliders 12 are fixed on the top surface of the horizontal mounting plate 10. The first driving device 13 is installed in the inner chamber 40 of the frame body 4 and connected to the horizontal mounting plate 10. The first driving device 13 is used to drive the horizontal mounting plate 10 to move in the first horizontal direction.

The first driving device 13 comprises: a first lead screw (not shown), a first nut (not shown), and a first motor (not shown). The first lead screw is rotated and installed on the frame body 4. The first nut is fixed to the horizontal mounting plate 10 and threaded to the first lead screw. The first motor is installed on the frame body 4 and its output shaft is connected to the first lead screw. When the first motor drives the first lead screw to rotate, the first lead screw drives the first nut and the horizontal mounting plate 10 to move together in the first horizontal direction.

The second movable module 2 includes: an installation frame 20, a second slide rail 21, and a second slider 22. The second slide rail 21 extends along the second horizontal direction and is fixed to the installation frame 20. The second slider 22 is installed onto the second slide rail 21 to move in the second horizontal direction. The installation frame 20 is fixed to the horizontal mounting plate 10, so that the second movable module 2 can move along the first horizontal direction with the horizontal mounting plate 10. In the illustrated embodiment, the installation frame 20 is rectangular in shape to enhance its structural rigidity and stability.

The second movable module 2 further includes a second driving device (not shown), which is installed on the installation frame 20 and connected to the second slider 22. The second driving device is used to drive the second slider 22 to move in the second horizontal direction.

The second driving device comprises a second lead screw (not shown), a second nut (not shown), and a second motor (not shown). The second lead screw is rotatably installed on the installation frame 20. The second nut is fixed to the second slider 22 and threaded to the second lead screw. The second motor is installed on the installation frame 20 and its output shaft is connected to the second lead screw. When the second motor drives the second lead screw to rotate, the second lead screw drives the second nut and the second slider 22 to move together in the second horizontal direction.

In the illustrated embodiments, when the welding device performs the welding task, the second movable module 2 can be partially or completely moved into the inner chamber 40 of the frame body 4 to further reduce the distance between the welding module 5 and the frame body 4. This can further improve the rigidity and stability of the welding device, and can further improve the welding accuracy.

The third movable module 3 comprises: a vertical mounting plate 30, a third slide rail (not shown), a third slider (not shown), and a mounting bracket 31. The third slide rail extends vertically and is fixed to the vertical mounting plate 30. The third slider is installed onto the third rail to allow for vertical movement. The mounting bracket 31 is fixed to the third slider to move vertically together with the third slider. The welding module 5 is installed on the mounting bracket 31 to move along the vertical direction with the mounting bracket 31. The vertical mounting plate 30 is fixed to the second slider 22, so that the third movable module 3 can move along the second horizontal direction with the second slider 22.

The third movable module 3 further comprises a third driving device 32, which is installed on the vertical mounting plate 30 and connected to the third slider. The third driving device 32 is used to drive the third slider to move vertically.

The third driving device comprises a third lead screw (not shown), a third nut (not shown), and a third motor (not shown). The third lead screw is rotatably installed on the vertical mounting plate 30. The third nut is fixed to the third slider and threaded to the third lead screw. The third motor is installed on the vertical mounting plate 30 and its output shaft is connected to the third lead screw. When the third motor drives the third lead screw to rotate, the third lead screw drives the third nut and the third slider to move vertically together.

The welding device further comprises a visual module 6, which is installed on the mounting bracket 31 of the third movable module 3 to be able to move synchronously with the mounting bracket 31 and the welding module 5. The welding module 5 is suitable for completing welding tasks under the visual guidance of the visual module 6. In the illustrated embodiment, the visual module 6 comprises at least one camera.

The welding module 5 comprises a welding head for heating and welding. The welding device also includes a welding head cleaning device 7, which is installed on the frame body 4 to remove pollutants, such as oxides or impurities, from the welding head of the welding module 5.

The frame body 4 comprises a crossbeam 42 located at its bottom, and the welding head cleaning device 7 is located outside the frame body 4 and fixed to the crossbeam 42 of the frame body 4.

The welding device further comprises a power supply 9, which is fixed on the top of the frame body 4 for supplying power to the welding device. In this way, the welding device does not require an external power source, making it more convenient to use.

The welding device further comprises an electric control box 8, which is installed in the inner chamber 40 of the frame body 4 for controlling the welding device.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A welding device, comprising:
a frame body;
a first movable module installed on the frame body and movable in a first horizontal direction;
a second movable module installed on the first movable module and movable in a second horizontal direction perpendicular to the first horizontal direction;
a third movable module installed on the second movable module and movable in a vertical direction perpendicular to the first and second horizontal directions; and
a welding module installed on the third movable module and movable together with the first, second, and third movable modules, the welding module is suspended outside the frame body, and the first movable module is provided in an inner chamber of the frame body to reduce the distance between the welding module and the frame body.

2. The welding device according to claim 1, wherein:
the first movable module comprises:
a pair of first slide rails extending along the first horizontal direction and spaced at a predetermined distance in the second horizontal direction; and
a pair of first sliders respectively installed on the pair of first sliders in a sliding manner; and
the frame body has a top frame, and the first slide rail is fixed to the inner side of the top frame.

3. The welding device according to claim 2, wherein the first movable module further comprises:
a horizontal mounting plate, and the pair of first sliders are fixed on the top surface of the horizontal mounting plate; and
a first driving device installed in the inner chamber of the frame body and connected to the horizontal mounting plate, the first driving device adapted to drive the horizontal mounting plate to move in the first horizontal direction.

4. The welding device according to claim 3, wherein the first driving device comprises:
a first lead screw rotatably installed on the frame body;
a first nut fixed to the horizontal mounting plate and threaded to the first lead screw; and
a first motor installed on the frame body and having an output shaft connected to the first lead screw, when the first motor drives the first lead screw to rotate, the first lead screw drives the first nut and the horizontal mounting plate to move together in the first horizontal direction.

5. The welding device according to claim 3, wherein the second movable module comprises:
an installation frame;
a second slide rail extending along the second horizontal direction and fixed to the installation frame; and
a second slider slidably installed on the second slide rail and movable in the second horizontal direction, the installation frame is fixed to the horizontal mounting plate, so that the second movable module is movable along the first horizontal direction with the horizontal mounting plate.

6. The welding device according to claim 5, wherein the second movable module further comprises a second driving device installed on the installation frame and connected to the second slider, the second driving device is adapted to drive the second slider to move in the second horizontal direction.

7. The welding device according to claim 6, wherein the second driving device comprises:
a second lead screw rotatably installed on the installation frame;
a second nut fixed to the second slider and threaded to the second lead screw; and
a second motor installed on the installation frame and having an output shaft connected to the second lead screw, when the second motor drives the second lead screw to rotate, the second lead screw drives the second nut and the second slider to move together in the second horizontal direction.

8. The welding device according to claim 1, wherein when the welding device performs welding operations, the second movable module is partially or completely moved into the inner chamber of the frame body and further reduces the distance between the welding module and the frame body.

9. The welding device according to claim 5, wherein the third movable module comprises:
a vertical mounting plate;
a third slide rail extending in the vertical direction and fixed to the vertical mounting plate;
a third slider slidably installed on the third slide rail and movable in the vertical direction; and
a mounting bracket fixed to the third slider and movable along the vertical direction with the third slider.

10. The welding device according to claim 9, wherein the welding module is installed on the mounting bracket and is movable along the vertical direction with the mounting bracket.

11. The welding device according to claim 10, wherein the vertical mounting plate is fixed to the second slider, so that the third movable module can move along the second horizontal direction with the second slider.

12. The welding device according to claim 11, wherein the third movable module further comprises a third driving device installed on the vertical mounting plate and connected to the third slider, the third driving device is adapted to drive the third slider to move in the vertical direction.

13. The welding device according to claim 12, wherein the third driving device comprises:
a third lead screw rotatably installed on the vertical mounting plate;
a third nut fixed to the third slider and threaded to the third lead screw; and
a third motor installed on the vertical mounting plate and having an output shaft connected to the third lead screw, when the third motor drives the third lead screw to rotate, the third lead screw drives the third nut and the third slider to move together in the vertical direction.

14. The welding device according to claim 10, further comprising a visual module installed on the mounting bracket of the third movable module and movable synchronously with the mounting bracket and the welding module, the welding module adapted to complete welding processes under the visual guidance of the visual module.

15. The welding device according to claim 1, wherein the welding module comprises a welding head for heating and welding.

16. The welding device according to claim 15, wherein the welding device further comprises a welding head cleaning device installed on the frame body to remove pollutants from the welding head of the welding module.

17. The welding device according to claim 16, wherein the frame body comprises a crossbeam located at its bottom, and the welding head cleaning device is fixed to the crossbeam of the frame body.

18. The welding device according to claim 17, wherein the head cleaning device is located outside the frame body.

19. The welding device according to claim 1, further comprising a power supply which is fixed on the top of the frame body for supplying power to the welding device.

20. The welding device according to claim 1, further comprising an electric control box which is installed in the inner chamber of the frame body for controlling the welding device.
